(19) United States
(12) Patent Application Publication
(10) Pub. No.: US 2008/0199651 A1
(43) Pub. Date: Aug. 21, 2008

(54) Pile Fabric for Apparel Excelling in Designability

(76) Inventor: Yoshitomo Matsumoto, Hyogo (JP)

Correspondence Address: BRINKS HOFER GILSON & LIONE, P.O. BOX 10395, CHICAGO, IL, 60610, US

(21) Appl. No.: 11/596,488

(22) PCT Filed: May 11, 2005
(86) PCT No.: PCT/JP05/08589

§ 371 Date: Dec. 6, 2007

(30) Foreign Application Priority Data
May 12, 2004 (JP) 2004-142514

(51) Int. Cl. B32B 33/00

(52) U.S. Cl. 428/89

(57) ABSTRACT

A pile fabric for apparel having designability and real appearance similar to natural fur imparted thereto. There is provided a pile fabric of high disignability with highly real appearance, which pile fabric has a pile-length-differentiated long/short two layer structure or long/middle/short three layer structure wherein with respect to the piles other than those of longest-pile layer corresponding to a fluff portion of natural fur, the tip region thereof has a color different from that of the root region. This pile fabric can find application in apparel, and can provide merchandise with real appearance as a substitute material for natural fur.

### BACKGROUND OF THE INVENTION

1. Field of the Invention

The present invention relates to a pile fabric excellent in designability and having a highly genuine appearance, to which a level-difference effect caused by color difference is given and which can be utilized as a substitute material for natural fur.

2. Description of the Background Art

Pile fabrics have been widely used in applications such as stuffed toys, fake fur, and interiors. Especially in application in apparel, merchandise having a genuine appearance has been highly demanded as a substitute material for natural fur. Regarding a genuine appearance, when natural fur such as that of fox, sable, mink or chinchilla is observed, it is found out that natural fur has a color-differentiated layer structure in which there is a change of color of hair from root to tip. It is also found that not only stinging hair but also a fluff portion has this color-differentiated layer structure.

Conventionally, as pile fabrics having a color-differentiated layer structure, there are two types of merchandise: merchandise utilizing, in terms of pile configuration, a difference in pile length; and merchandise in which the tip region of pile fabric is chip-printed or discharged in the processing stage. Regarding the former, a commonly used method is such that in terms of raw material constitution, high shrinkage raw cotton and low shrinkage raw cotton with different colors are mixed, the surface of the mixture is cut into a uniform length, and then heating is conducted to develop shrinkage in the fiber, so that a layer structure utilizing the difference in shrinkage rate is developed (for example, see Patent Document 1). Another method is such that for high pile fabric, raw cottons with different colors and different fiber lengths are mixed to develop a layer structure caused by a difference in pile length. Merchandise obtained by the above-mentioned methods is pile merchandise in which the colors of stinging-hair and a fluff hair are differentiated so as to have a layer structure in which there is an artificial change in color when seen as a whole of merchandise; that is, such merchandise does not provide a change in color in the pile itself. On the other hand, the latter is merchandise in which the pile itself has portions of different colors, and therefore, such an expression is possible that the color of a single fiber is as changeable longitudinally as natural fur. The most effective method to express a natural fur appearance has been such that by combining the above methods, the tip region of pile fabric having a plurality of layers is colored. However, in the above-mentioned merchandise, only the tip region of the longest pile layer is colored or decolorized, and a color-differentiated layer structure has not been expressed in a portion corresponding to the fluff hair in natural fur.

### Patent Document 1: Japanese Unexamined Patent Publication No. 08-260289

### DISCLOSURE OF THE INVENTION

### Technical Problems to be Solved

It is an object of the present invention to provide a pile fabric to which a more genuine appearance and designability is given in the above-mentioned pile fabric.

### Means to Solve the Problems

A pile fabric according to the present invention is provided having a plurality of pile-length-differentiated layers, wherein the tip region of a pile layer other than the longest pile layer has a color different from that of the root region of the pile layer. The above-mentioned plurality of pile-length-differentiated layers may be of a long/short two layer structure or a long/middle/short three layer structure. Furthermore, the above-mentioned plurality of pile-length-differentiated layers may be obtained by a combination of a nonshrinkable fiber and a shrinkable fiber.

In the above-mentioned pile fabric, the tip region of the longest pile layer may have a color different from that of the pile layer other than the longest pile layer. Furthermore, the tip region of the pile layer other than the longest pile layer may be colored by printing so as to have a color different from that of the root region of the pile layer. In this case, it is preferable that the color of the longest pile layer, before being printed, is in the range of neutral color to dark color, and the color of the pile layer other than the longest pile layer, which is colored by printing, is in the range of pale color to neutral color.

In the above-mentioned pile fabric, the fabric may have such a combination of hues that the hue of the tip region of the longest pile layer is different from the hue of the pile layer other than the longest pile layer. Furthermore, the tip region of the pile layer other than the longest pile layer may be white-color discharged or color discharged so as to have a color different from that of the root region of the pile layer. In this case, the pile layer other than the longest pile layer may be colored using coloring agent containing dischargeable coloring agent. Furthermore, the plurality of pile-length-differentiated layers may be obtained by a combination of a nonshrinkable fiber and a shrinkable fiber which is colored by dyeing.

### EFFECT OF THE INVENTION

As described above, the pile fabric according to the present invention in which the color of the tip region of the pile layer other than the longest pile layer is different from that of the root region of the pile layer has a configuration such that the pile layer other than the longest pile layer, which corresponds to a fluff portion of natural fur, has a color-differentiated layer structure and is excellent in designablity and has a highly genuine appearance. Consequently, by using the above-mentioned pile fabric, it is possible to manufacture merchandise having a genuine appearance as a substitute material for natural fur for apparel use.

### BEST MODE FOR CARRYING OUT THE INVENTION

As a method for preparing the pile fabric according to the present invention, a pile fabric made of yarns such as woven pile, boa, raschel as pile material may be prepared, or high pile made of sliver as pile material may be prepared. Among these, high pile has more degree of freedom in design than do other pile fabrics, and therefore is suitable for manufacturing merchandise having a genuine appearance as a substitute material for natural fur for apparel use.

As a pile material used in the present invention, a material commonly used in making pile fabrics including synthetic fiber such as acrylic fiber, acrylic-based fiber and polyester, and natural fiber such as cotton or wool may be used; thus, a pile material is not specifically limited. Still, as a shrinkable fiber (high shrinkage raw cotton), it is preferable to use synthetic fiber for a constant shrinkage rate. Furthermore, regarding a ground yarn, a material which is commonly used such as acrylic fiber, polyester and cotton may be used.

The term “a plurality of pile-length-differentiated layers,” as used herein, refers to a state in which piles having a difference in pile length exist not in a random manner but at a specific ratio on a pile fabric, with the resulting appearance of the pile fabric being such that the long and short layers of fiber can be discriminated. Furthermore, the difference in pile length refers to a difference in the length (pile length) from the base fabric to the pile tip. When it is said that there is a difference in pile length, it is meant that the difference in pile length is 1.5 mm or more, and preferably, 2 mm or more.

Regarding pile fabrics having a plurality of pile-length-differentiated layers, there are two methods to obtain a plurality of length-differentiated layers, as mentioned above. As one method, the material configuration is made up of a shrinkable fiber (high shrinkage raw cotton) and a nonshrinkable fiber (low shrinkage raw cotton) with different colors, which are mixed and cut into uniform length for a uniform surface, followed by heating to develop shrinkage in the fibers and develop a layer structure utilizing the difference in shrinkage rate. The other method is regarding a high pile fabric such that material fibers (raw cottons) with different colors and different fiber lengths are mixed to develop a fiber-length differentiated layer structure utilizing the difference in fiber length. While by the use of the above-mentioned two methods a plurality of pile-length-differentiated layers can be obtained, the method utilizing a difference in shrinkage rate provides a plurality of pile-length-differentiated layers comprising short-length piles having uniform length. Therefore, a clearer level difference can be obtained. Furthermore, the above-mentioned fibers with different colors refer to fibers whose hues and/or depths of color are different from each other.

When pile-length differentiated pile layers are obtained by utilizing the difference in shrinkage rate of fibers, the state in which the long and short pile layers of fiber can be discriminated refers to the following state. Referring to the schematic diagram of a pile shown in FIG. 1, for piles having a two layer structure, the difference in pile length (a) between the longest pile layer and the pile layer other than the longest pile layer is 1.5 mm or more, and more preferably, 2 mm or more. When the difference in pile length between the longest pile layer and the pile layer other than the longest pile layer is less than 1.5 mm, a level-difference effect cannot be expected because the difference in pile length between the pile layers is excessively small. In order to obtain the above-mentioned level-difference effect, it is necessary that the difference in shrinkage rate between a fiber used for the short-length pile layer and a fiber used for the long-length pile layers is 8% or more, and more preferably 10% or more. When the difference in shrinkage rate is 8% or less, crimp expands during polisher processing, and thus the level difference becomes unclear, making it impossible to provide a layer structure. The shrinkage rate, as used herein, refers to dry-heat shrinkage rate obtained in the following manner. A fiber was treated at 130 C.+ for 20 minutes, under no tension, using blast constant-temperature dryer, and single fiber lengths before and after shrinkage were measured. Then, the shrinkage rate was obtained based on the following formula.

Shrinkage (%)=[(L₀−L₁)/L₀]×100 (where, L₀ indicates single fiber length before shrinkage and L₁indicates single fiber length after shrinkage).

When pile-length differentiated pile layers are obtained by utilizing the difference in shrinkage rate of fibers, it is preferable that the length of the longest pile layer is in a range of 7 mm to 40 mm, and more preferably, 8 mm to 30 mm. When the length of the longest pile layer is less than 7 mm, the level difference becomes unclear even there is a sufficient difference in shrinkage rate. When the length of the longest pile layer exceeds 40 mm, the length of the short-length pile layer is not uniform, in which case a shrinkable fiber may not be used; a similar effect can be obtained by mixing material fibers (raw cotton) having a difference in fiber length which will be mentioned later.

On the other hand, when pile-length differentiated pile layers are obtained by utilizing the difference in fiber length, the state in which pile the long and short layers of fiber can be discriminated refers to the following state. Referring to the schematic diagram of a pile shown in FIG. 2, for piles having a two layer structure, the difference in pile length (b) between the longest pile layer and the pile layer other than the longest pile layer is 1.5 mm or more, and more preferably, 2 mm or more. In addition, the above-mentioned state also refers to such a state that among the portions constituting the upper 4 mm fiber of the longest pile layers, which is indicated by the symbol c in FIG. 2, 95 wt % or more, and more preferably 98 wt % or more of the portions constitute the longest pile layers.

In high pile, the fibers constituting the pile portion are knitted in the ground yarn at random positions, and therefore material fibers of the same fiber length are made into a mixture of piles of different lengths. In comparison with the case of using shrinkable fibers, the length of the short-length pile layer cannot be made uniform, making it impossible to clearly specify the length of the short-length pile layer. In view of this, in this case, the above-mentioned state refers to a state in which the difference in pile length (b) between the longest pile layer and the pile layer other than the longest pile layer is 1.5 mm or more, and more preferably 2 mm or more. In addition, the above-mentioned state also refers to such a state that among the portions constituting the upper 4 mm fiber of the longest pile layers, which is indicated by the symbol c in FIG. 2, 95 wt % or more, and more preferably 98 wt % or more of the portions constitute the longest pile layers.

When the state in which the long and short pile layers of fiber can be discriminated is obtained by utilizing the difference in the fiber length of material fibers (raw cotton), it is necessary that the length of a fiber used for the long-length pile portion is at least 1.2 times or more, preferably 1.3 times or more, and more preferably 1.4 times or more than the length of a fiber used for the short-length pile portion. When the length of a fiber used for the long-length pile portion is less than 1.2 times the length of a fiber used for the short-length pile portion, the pile-length distributions for the longest pile layer and the pile layer other than the longest pile layer become closely analogous, making it impossible to provide a layer structure in terms of appearance. On the other hand, in the case of a 1.4 time or more difference in fiber length, the layers of fiber can be clearly discriminated even when there is a small amount of the components of the longest pile layers. The term fiber length, as used herein, refers to the length of a fiber after high pile processing, and when a shrinkable fiber is used as a raw material, calculation is made based on the fiber length after shrinkage. As one example, the length of a highly shrinkable fiber having 30% of shrinkage rate and 32 mm of fiber length should be considered to be 22.4 mm in fiber length in calculation. When a state in which the long and short layers can be discriminated is obtained by utilizing the difference in fiber length of a material fiber (raw cotton), it is preferable that the length of the longest pile layer is 12 mm or longer, preferably 15 mm or longer, and more preferably 20 mm or longer.

Furthermore, it is preferable that the plurality of pile-length-differentiated layers in pile fabric according to the present invention have a long/short two layer structure or long/middle/short three layer structure. The long/short two layer structure is as defined above, and the long/middle/short three layer structure will be defined as follows. Similarly to the long/short two layers, when long/middle/short layers are obtained by utilizing the difference in shrinkage rate of fibers, the state in which long/middle/short pile layers can be discriminated refers to the following state. Referring to the schematic diagram of a pile of a three layer structure shown in FIG. 3, the difference in pile length (d) between the longest pile layer and a pile layer other than the longest pile layer is 1.5 mm or more, and more preferably 2 mm or more; and the difference in pile length (e) between the middle-length pile layer and the short-pile layer is 1.5 mm or more, and more preferably 2 mm or more. In this case, in order to also obtain the state in which long/middle/short pile layers can be discriminated, it is necessary that the difference in shrinkage rate between a fiber used for the middle-length pile layer and a fiber used for the long-length pile layer is 8% or more, and more preferably 10% or more; and the difference in shrinkage rate between a fiber used for the short-length pile layer and a fiber used for the middle-length pile layer is 8% or more, and more preferably 10% or more. When the difference in shrinkage rate is less than 8%, crimp expands during polisher processing, and thus the level difference becomes unclear, making it impossible to provide a layer structure.

When long/middle/short pile layers are obtained by utilizing the difference in fiber length of a material fiber (raw cotton), the state in which the long/middle/short pile layers can be discriminated refers to the following state: referring to the schematic diagram of a three layer pile shown in FIG. 4, the difference in pile length (f) between the longest pile layer and the middle-length pile layer is 1.5 mm or more, and more preferably 2 mm or more; among the fiber portions present in the area of the upper 4 mm portions of the longest pile layers, which is indicated by the symbol g in FIG. 4, 95 wt % or more, and more preferably 98 wt % or more of the fiber portions constitute the longest pile layers; and further, the difference in pile length (h) between the middle-length pile layer and the short length pile layer is 1.5 mm or more, and more preferably 2 mm or more; among the fiber portions present in the area of the upper 4 mm portions of the middle-length pile layers, which is indicated by the symbol i in FIG. 4, preferably 98 wt % or more of the fiber portions constitute the middle-length pile layers except for fiber portions constitute the longest pile layers. In this case, in the longest pile layer, it is necessary to use a fiber having a length that is at least 1.2 times or more, preferably 1.3 times or more, and more preferably 1.4 times or more than the length of a fiber used for the middle-length pile layer; and in the middle-length pile layer, it is necessary to use a fiber having a length that is at least 1.2 times or more, preferably 1.3 times or more, and more preferably 1.4 times or more than the length of a fiber used for the short-length pile layer. When the length of a fiber used for the longest pile layer is less than 1.2 times than that of a fiber used for the middle-length pile layer, or the length of a fiber used for the middle-length pile layer is less than 1.2 times than that of a fiber used for the short-length pile layer, the pile-length distributions for the longest pile layer and the middle-length pile, or the pile length distributions for the middle-length pile layer and the short-length pile layer are closely analogous, making it impossible to provide a layer structure in terms of appearance. On the other hand, when a difference in fiber length is 1.4 time or more, the layers of fiber can be clearly discriminated even when there is a small amount of the components of the longest pile layers.

When long/middle/short pile layers are obtained such that the long/middle pile layers are obtained by utilizing the difference in shrinkage rate and the middle/short pile layers are obtained by utilizing the difference in fiber length, the state in which the long/middle/short pile layers can be discriminated refers to the following state. Referring to the schematic diagram of a pile of a three layer structure shown in FIG. 5, the difference in pile length (j) between the longest-pile layer and a pile layer other than the longest-pile layer is 1.5 mm or more, and more preferably 2 mm or more; and the difference in pile length (k) between the middle-length pile layer and the short-length pile layer is 1.5 mm or more, and more preferably 2 mm or more. In addition, the above-mentioned state also refers to such a state that among the fiber portions present in the area of the upper 4 mm portions of the middle-length pile layers, which is indicated by the symbol 1 in FIG. 5, 98 wt % or more of the fiber portions constitute the middle-length pile layers. In this case, in order to obtain the state in which long/middle/short pile can be discriminated, it is necessary that the difference in shrinkage rate between a fiber used for the middle-length pile layer and a fiber used for the longest pile layer is 8% or more, and more preferably 10% or more, and for the middle-length pile layer, it is necessary to use a fiber having a length of fiber that is at least 1.2 time or more, preferably 1.3 time or more, and more preferably 1.4 time or more than the length of a fiber used for the short-length pile layer. The term fiber length, as used herein, refers to the length of fiber after high pile processing, and when a shrinkable fiber is used as a raw material, calculation is made based on the fiber length after shrinkage.

In addition to the above-mentioned method to obtain a layer structure, in order to obtain such an appearance of the pile fabric as to have a state in which the long and short pile layers can be discriminated, it is necessary that the shorter-length pile layers constitute at least 20 wt % or more, preferably 30 wt % or more, and more preferably 40 wt % or more of the components. Because the pile construction becomes more mixed in tone toward the pile bottom, it is necessary to select a suitable color. It is therefore difficult to obtain a pile having a structure of four or more layers, e.g., longest/middle/short/extremely-short layers. Even if a pile having the above-mentioned structure is obtained, a plurality of long-length piles and short-length piles exist in an almost randommanner, making it difficult to develop layers sufficiently recognizable to the eye. Even if a layer structure is obtained, the fibers are densely clustered at the bottom of the pile, and there is an extreme scarcity of components for the tip region of pile. Consequently, it is impossible to obtain a sufficient quality for a pile fabric, to say nothing of a substitute material for natural fur.

In the present invention, the above-described pile fabric is colored or decolorized by chip printing in order to obtain a desired pile fabric. Common methods used in chip printing such as roller print, screen print, rotary screen print may be used to attach printing starch. In attaching printing starch, it is necessary to attach printing starch not only to the longest pile layer but also to the pile layer other than the longest pile layer. The term printing starch, as used herein, encompasses not only printing starch used for coloring, but also discharging starch with which white-color discharging and color discharging are provided. This is because the color of the tip region of the pile layer other than the longest pile layer can be changed not only by coloring but also by decolorizing. In this event, it is preferable that the color of the tip region of the pile layer other than the longest pile layer is colored or decolorized by printing or discharging to be of a color different from that of the longest pile layer.

If the color of the tip region of the pile layer other than the longest pile layer is the same as the color of the tip region of the longest pile layer, the resulting appearance appears to be the same as the case in which only the tip region is chip-printed. Consequently, even when the color of the tip region of the pile layer other than the longest pile layer is different from the color of the root of the pile layer, this visual effect is limited.

When obtaining a pile in which the color of the tip region of the longest pile layer is different from that of the tip region of the pile layer other than the longest pile layer, the method of manufacture varies according to the type of the printing starch used in the above-mentioned chip-printing process. Here it is very important to select a color for ground dyeing of the longest pile layer and the pile layer other than the longest pile layer, and a color for the discharging starch. First, when printing starch used for ordinary coloring is used as printing starch, it is preferable that the color of the pile layer other than the longest pile layer is in the range of pale color to neutral color because the pile layer other than the longest pile layer needs to be colored by printing. The term “a color in the range of pale color to neutral color,” as used herein, refers to such a color that can be dyed at, in terms of cation dyeing, 1.5% omf or less, preferably 1.0% omf or less, more preferably 0.5% or less, in terms of 100% equivalent. The color of the longest pile layer is preferably in the range of neutral color to dark color so that there is only a small change of color after subjected to printing by printing starch. The term “a color in the range of neutral color to dark color,” as used herein, refers to such a color that can be dyed at, in terms of cation dyeing, 1.0% omf or more, preferably 1.5% omf or more, more preferably 2.0% or more, in terms of 100% equivalent.

A pile fabric in which the color of the tip region of the longest pile layer is different from the color of the tip region of the pile layer other than the longest pile layer can be obtained using the pile fabric having the above-mentioned constitution and by attaching printing starch not only to the longest pile layer but also to the pile layer other than the longest pile layer by chip-printing to color both pile layers. In this event, it is preferable that the color of chip-printing is in the range of pale color to neutral color so as to color the pile layer other than the longest pile layer and provide only a small change of the color of the longest pile layer. The term “a color in the range of pale color to neutral color,” as used herein, refers to such a color that when a white fabric of the same constitution is printed by the same method, the color of the pile tip can be dyed at, in terms of cation dyeing, 1.5% omf or less, preferably 1.0% omf or less, more preferably 0.5% or less, in terms of 100% equivalent.

In the above, an example of color differentiation by means of the difference in the depth of color was described. However, a pile fabric in which the color of the tip region of the longest pile layer is different from the color of the tip region of the pile layer other than the longest pile layer can be obtained not only by using colors having different depths, but also by using colors having remarkably different hues for the tip region of the longest pile layer and the color of the pile layer other than the longest pile layer. Here colors having remarkably different hues refer to colors that are more than 2 Hues apart in terms of Hue, where the hue of longest pile layer and that of the pile layer other than the longest pile layer are indicated by the Munsel color system. For example, when the hue of the longest pile layer is 5R in terms of a Munsel hue circle, then the hue of the pile layer other than the longest pile layer should be classified into a position that is apart beyond 5Y or 5P. In this case, these colors can be said to have remarkably different hues even if they are on the same depth level.

Next, when discharging starch used for white discharging or color discharging is used as printing starch, the color of the pile layer other than the longest pile layer is colored using coloring agent containing dischargeable coloring agent, and the tip region of the pile layer is decolorized by discharging. A combination of colors is selected such that the color of the longest pile layer after being discharged is different from the color of the tip region of the pile layer other than the longest pile layer. Thus, a pile fabric in which the hue of the longest pile layer is different from the hue of the tip region of the pile layer other than the longest pile layer can be obtained.

When color of the tip region of the pile layer other than that of the longest pile layer is changed using discharging starch, in the case of using a shrinkable fiber, it is preferable from the view point of color selection to use a shrinkable fiber that is colored by dyeing, instead of using a shrinkable fiber that is solution-dyed. Here, a shrinkable fiber that is colored by dyeing refers to a fiber to which a shrinkage property is given by fiber drawing after being tow-dyed, and to a fiber that is dyed without developing all of shrinkage at the stage of cotton-dyeing so as to leave a residual shrinkage rate sufficient for obtaining a level-difference effect.

### EXAMPLES

The present invention will be described below referring to examples. It should be noted, however, that the present invention is not limited to the examples.

### Example 1

A sliver was prepared by mixing 7 wt % of modacrylic fiber (KANEKARON RFM, available from KANEKA CORPORATION) with 22 dtex×76 mm, which was solution-dyed to be black, 55 wt % of modacrylic fiber (KANEKARON RCL, available from KANEKA CORPORATION) with 7.8 dtex×38 mm, which was dyed to be beige, and 38 wt % of modacrylic fiber (KANEKARON AH, available from KANEKA CORPORATION) with 3.3 dtex×38 mm, which was dyed to be beige. The obtained sliver was knitted to be a pile fabric using sliver knitting machine, common processing was conducted in the processes of tentering, polisher, shearing and brush, and a high pile having a final pile length of 50 mm was prepared. The obtained pile was a high pile having a pile-length differentiated long/short two layer structure, wherein the longest pile layer was black and the other pile layer was beige, and the difference in length between the longest pile layer and the other pile layer was approximately 25 mm. Brown printing starch was chip-printed to the pile fabric using roller print, whereby printing starch was attached to the black longest pile layer and the beige pile layer. Then, steam treatment, washing, and reprocessing were conducted. As a result, a raccoon-like high pile in which the beige pile layer was chip-printed to be brown was obtained.

### Example 2

A sliver was prepared by mixing 30 wt % of modacrylic fiber (KANEKARON ELP, available from KANEKA CORPORATION) with 27 dtex×51 mm, which was dyed to be gold-color with reduction resistant dye, 50 wt % of acrylic fiber (H105, available from MITSUBISHI RAYON CO LTD) with 5.6 dtex×38 mm, which was dyed to be gray with dischargeable dye, and 20 wt % of acrylic fiber (K691, available from Exlan Co., Ltd.) with 3.3 dtex×38 mm, which was dyed to be gray with dischargeable dye. The obtained sliver was knitted to be a pile fabric using sliver knitting machine, common processing was conducted in the processes of tentering, polisher, shearing and brush, and a high pile having a final pile length of 40 mm was prepared. The obtained pile was a high pile having a pile-length differentiated long/short two layer structure, wherein the longest pile layer was gold-color and the other pile layer was gray, and the difference in length between the longest pile layer and the other pile layer was approximately 15 mm. Discharge printing starch for white-color discharge printing was chip-printed to the pile fabric using screen print, whereby the discharge printing starch was attached to the gold-color longest pile layer and gray pile layer. Then, steam treatment, washing, and reprocessing were conducted. As a result, a sable-like high pile in which gray pile layer was chip-color discharged to be white was obtained.

### Example 3

A sliver was prepared by mixing 30 wt % of modacrylic fiber (KANEKARON AH, available from KANEKA CORPORATION) with 3.3 dtex×38 mm, which was solution-dyed to be dark-brown, and 70 wt % of highly shrinkable modacrylic fiber (KANEKARON LAN HB, available from KANEKA CORPORATION, shrinkage rate: 22%) with 7.8 dtex×38 mm, which was solution-dyed to be beige. The obtained sliver was knitted to be a pile fabric using sliver knitting machine, common processing was conducted in the processes of tentering, polisher, shearing and brush, and a high pile having a final pile length of 18 mm was prepared. The obtained pile was a high pile having a pile-length differentiated long/short two layer structure, wherein the longest pile layer was dark-brown and the other pile layer was beige, and the difference in length between the longest pile layer and the other pile layer was approximately 3 mm. Brown printing starch was chip-printed to the pile fabric using screen print, whereby the printing starch was attached to the dark-brown longest pile layer and beige pile layer. Then, steam treatment, washing, and reprocessing were conducted. As a result, an Angora rabbit-like high pile in which beige pile layer was chip-printed to be brown was obtained.

### Example 4

A carded wool yarn comprising 30 wt % of modacrylic fiber (KANEKARON RMK, available from KANEKA CORPORATION) with 12 dtex, which was solution-dyed to be dark-brown, 70 wt % of highly shrinkable modacrylic fiber (KANEKARON FHS, available from KANEKA CORPORATION, shrinkage rate: 32%) with 2.2 dtex, which was solution-dyed to be beige was prepared. The carded wool yarn was knitted to be a pile fabric using fraise knitting machine, common processing was conducted in the processes of tentering, brush, polisher and shearing, and a boa having a final pile length of 18 mm was prepared. The obtained pile was a high pile having a pile-length differentiated long/short two layer structure, wherein the longest pile layer was dark-brown and the other pile layer was beige, and the difference in length between the longest pile layer and the other pile layer was approximately 5 mm. Brown printing starch was chip-printed to the pile fabric using screen print, whereby the printing starch was attached to the dark-brown longest pile layer and the beige pile layer. Then, steam treatment, washing, and reprocessing was conducted. As a result, a mink-like boa in which the beige pile layer was chip-printed to be brown was obtained.

### Example 5

A carded wool yarn comprising 30 wt % of modacrylic fiber (KANEKARON AH, available from KANEKA CORPORATION) with 5.6 dtex, which was solution-dyed to be dark-brown, 50 wt % of white-colored highly shrinkable modacrylic fiber (KANEKARON LAN HB, available from KANEKA CORPORATION, shrinkage rate: 22%) with 7.8 dtex, and 20 wt % of white-colored highly shrinkable modacrylic fiber (KANEKARON FHS, available from KANEKA CORPORATION, shrinkage rate: 32%) with 2.2 dtex was prepared. The carded wool yarn was knitted to be a pile fabric using textile machine, common processing was conducted in the processes of tentering, brush, polisher, and shearing, and a woven pile having a final pile length of 25 mm was prepared. The obtained pile was a high pile having a pile-length differentiated long/short two layer structure, wherein the longest pile layer was dark-brown and the other pile layer was white, and the difference in length between the longest pile layer and the other pile layer was approximately 4 mm. Light-brown printing starch was chip-printed to the pile fabric using roller print, whereby the printing starch was attached to the dark-brown longest pile layer and the white pile layer. Then, steam treatment, washing, and reprocessing were conducted. As a result, a rabbit-like woven pile in which the white pile layer was chip-printed to be brown was obtained.

### Example 6

A sliver was prepared by mixing 30 wt % of modacrylic fiber (KANEKARON ELP, available from KANEKA CORPORATION) with 27 dtex×76 mm, which was solution-dyed to be dark-brown, 40 wt % of modacrylic fiber (KANEKARON RLM, available from KANEKA CORPORATION) with 12 dtex×44 mm, which was solution-dyed to be beige, and 30 wt % of highly shrinkable modacrylic fiber (KANEKARON AHD, available from KANEKA CORPORATION, shrinkage rate: 32%) with 4.4 dtex×32 mm, which was solution-dyed to be black. The obtained sliver was knitted to be a pile fabric using sliver knitting machine, common processing was conducted in the processes of tentering, polisher, shearing, and brush, and a high pile having a final pile length of 50 mm was prepared. The obtained pile was a high pile having a pile-length differentiated long/middle/short three layer structure, wherein the longest pile layer was dark-brown, the bottom of the pile was black, and the other pile layer was beige; and the difference in length between the longest pile layer and the middle-length pile layer was approximately 20 mm, and the difference in length between the middle-length pile layer and the short-pile layer was approximately 15 mm. Reddish-brown printing starch was chip-printed to the pile fabric using screen print, whereby the printing starch was attached to the dark-brown longest pile layer and the beige pile layer. Then, steam treatment, washing, and reprocessing were conducted. As a result, a sable-like high pile in which the beige pile layer was chip-printed to be reddish-brown was obtained.

### Example 7

A sliver was prepared by mixing 30 wt % of modacrylic fiber (KANEKARON RFM, available from KANEKA CORPORATION) with 12 dtex×51 mm, which was solution-dyed to be black, and 70 wt % of dyeable and highly shrinkable modacrylic fiber (KANEKARON MCS, available from KANEKA CORPORATION, shrinkage rate after dyeing: 32%) having a fineness of 4.4 dtex and fiber length of 32 mm, which was dyed to be reddish-brown with a combination of dischargeable dye and reduction resistant dye. The obtained sliver was knitted to be a pile fabric using sliver knitting machine, common processing was conducted in the processes of tentering, polisher, shearing, and brush, and a high pile having a final pile length of 18 mm was prepared. The obtained pile was a high pile having a pile-length differentiated long/short two layer structure, wherein the longest pile layer was black and the other pile layer was reddish-brown, and the difference in length between the longest pile layer and the other pile layer was approximately 4 mm. Discharge printing starch for white-color discharge printing was chip-printed to the pile fabric using screen print, whereby the discharge printing starch was attached to the black longest pile layer and the reddish-brown pile layer. Then, steam treatment, washing, and reprocessing were conducted. As a result, a mink-like high pile in which the reddish-brown pile layer was chip discharge printed to be orange-color with reduction resistant dye was obtained.

### Comparative Example 1

A sliver was prepared by mixing 7 wt % of modacrylic fiber (KANEKARON RFM, available from KANEKA CORPORATION) with 22 dtex×76 mm, which was solution-dyed to be black, 55 wt % of modacrylic fiber (KANEKARON RCL, available from KANEKA CORPORATION) with 7.8 dtex×38 mm, which was dyed to be beige, and 38 wt % of modacrylic fiber (KANEKARON AH, available from KANEKA CORPORATION) with 3.3 dtex×38 mm, which was dyed to be beige. The obtained sliver was knitted to be a pile fabric using sliver knitting machine, common processing was conducted in the processes of tentering, polisher, shearing, and brush, and a high pile having a final pile length of 50 mm was prepared. The obtained pile fabric was a high pile having a pile-length differentiated long/short two layer structure, wherein the longest pile layer was black and the other pile layer was beige; and the difference in length between the longest pile layer and the other pile layer was approximately 25 mm. However, the hue of the short pile was homogeneous, obtaining nothing special in appearance. Comparative Example 2

A sliver was prepared by mixing 50 wt % of modacrylic fiber (KANEKARON RCL, available from KANEKA CORPORATION) with 17 dtex×51 mm, which was dyed to be beige, and 50 wt % of modacrylic fiber (KANEKARON AH, available from KANEKA CORPORATION) with 3.3 dtex×38 mm, which was dyed to be beige. The obtained sliver was knitted to be a pile fabric using sliver knitting machine, common processing was conducted in a process of tentering, polisher, shearing, and brush, and a high pile having a final pile length of 25 mm was prepared. The obtained pile was a high pile which was beige as a whole. Reddish-brown printing starch was chip-printed to the pile fabric using screen print, whereby the printing starch was attached to the beige pile layer. Then, steam treatment, washing, and reprocessing were conducted. As a result, a high pile in which the beige pile layer was chip-printed to be reddish-brown was obtained. Although the obtained pile fabric had a two layer structure in which the hair tip was dyed, there was no difference in length between the two layers, obtaining nothing special in appearance.

### BRIEF DESCRIPTION OF THE DRAWINGS

FIG. 1 is a schematic diagram showing a pile having a two layer structure obtained by difference in shrinkage rate of material fibers.

FIG. 2 is a schematic diagram showing a pile having a two layer structure obtained by difference in fiber length of material fibers.

FIG. 3 is a schematic diagram showing a pile having a three layer structure obtained by difference in shrinkage rate of material fibers.

FIG. 4 is a schematic diagram showing a pile having a three layer structure obtained by difference in fiber length of material fibers.

FIG. 5 is a schematic diagram showing a pile having a three layer structure obtained by difference in shrinkage rate of material fibers and difference in fiber length of material fibers.

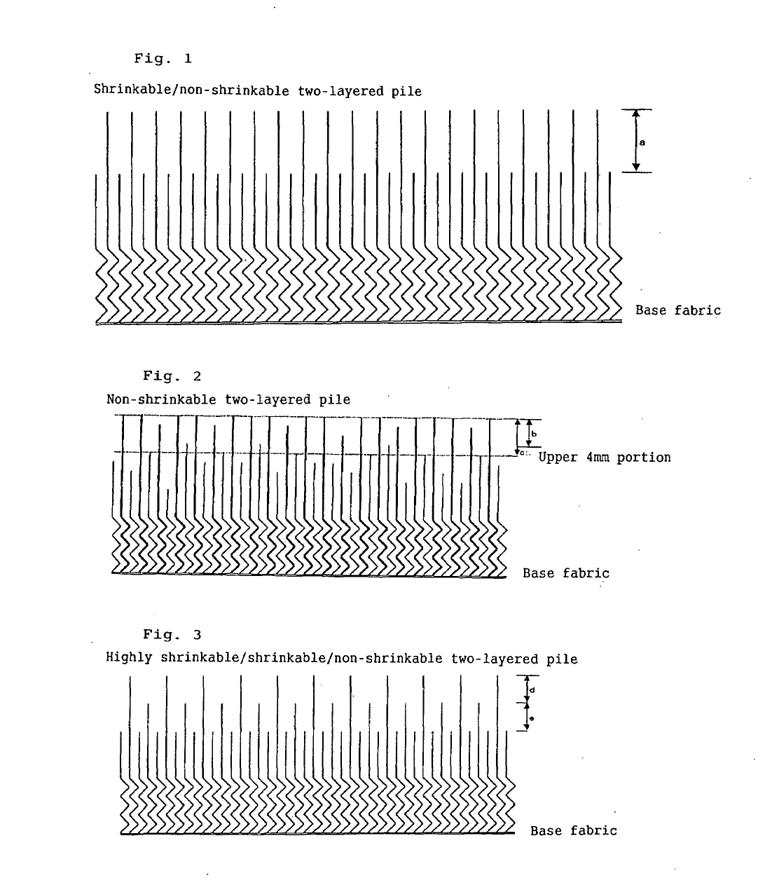

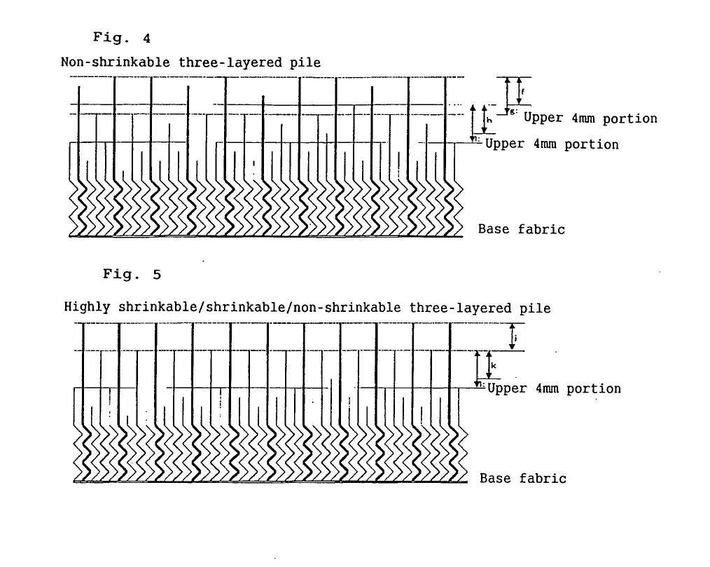

1. A pile fabric comprising a plurality of pile-length-differentiated layers, wherein a tip region of a pile layer other than a longest pile layer has a color different from a color of a root region of the pile layer other than the longest pile layer.

2. The pile fabric according to claim 1, wherein the pile fabric has a pile-length-differentiated long/short two layer structure or a long/middle/short three layer structure.

3. The pile fabric according to claim 1 or 2, wherein the plurality of layers are obtained by a combination of a nonshrinkable fiber and a shrinkable fiber.

4. The pile fabric according to claim 1 or 2, wherein the tip region of the longest pile layer has a color different from the color of the tip region of the pile layer other than the longest pile layer.

5. The pile fabric according to claim 1 or 2, wherein the tip region of the pile layer other than the longest pile layer is colored by printing so as to have a color different from the color of the root region of the pile layer.

6. The pile fabric according to claim 1 or 2, wherein the color of longest pile layer, before being printed, is in the range of neutral color to dark color, and the color of the pile layer other than the longest pile layer, which are colored by printing, is in the range of pale color to neutral color.

7. The pile fabric according to claim 1 or 2, wherein a hue of the tip region of the longest pile layer is different from a hue of the pile layer other than the longest pile layer.

8. The pile fabric according to claim 1 or 2, wherein the tip region of the pile layer other than the longest pile layer is white-color discharged or color discharged so as to have a color different from the color of the root region of the pile layer other than the longest pile layer.

9. The pile fabric according to claim 8, wherein the pile layer other than the longest pile layer is colored using coloring agent containing dischargeable coloring agent.

10. The pile fabric according to claim 9, wherein the plurality of layers are obtained by a combination of a nonshrinkable fiber and a shrinkable fiber colored by dyeing.
